(19) United States
(12) Patent Application Publication
(10) Pub. No.: US 2015/0143912 A1
(43) Pub. Date: May 28, 2015

(54) APPARATUS FOR NONDESTRUCTIVE CRACK INSPECTION

(71) Applicant: UNIST ACADEMY-INDUSTRY RESEARCH CORPORATION, Ulsan (KR)

(72) Inventors: Franklin Bien, Ulsan (KR); Hyon Gi Yoo, Seoul (KR); Zhenyi Liu, Ulsan (KR); Nguyen Ngoc Quang, Ulsan (KR); Seul Ki Rom Kim, Gwangju (KR); Joo Hyeob Song, Busan (KR)

(21) Appl. No.: 14/555,713

(22) Filed: Nov. 28, 2014

(30) Foreign Application Priority Data
Nov. 28, 2013 (KR) 10-2013-0146242

(51) Int. Cl. G01N 29/04

(52) U.S. Cl. CPC G01N 29/04; G01N 2291/263
USPC 73/646

(57) ABSTRACT

According to the present invention, it is possible to determine a defect on a product caused in a pressing process by applying a predetermined acoustic signal to an object to be inspected and then sensing propagation of the applied signal, and it is possible to improve inspection performance, using an acoustic sensor capable of sensing sounds in an audible band and a sound collector that collects sounds and prevents noise. Further, it is possible to prevent defective panels from being put into the following process line by inspecting panels produced in a panel production line.

### CROSS-REFERENCE TO RELATED APPLICATIONS

This application claims the priority of Korean Patent Application No. 10-2013-0146242 filed on Nov. 28, 2013, in the Korean Intellectual Property Office, the disclosure of which is incorporated herein by reference.

### BACKGROUND OF THE INVENTION

1. Field of the Invention

The present invention relates to an apparatus for nondestructive crack inspection, and more particularly, to an apparatus for nondestructive crack inspection that can perform nondestructive inspection, using a detachable audio-band acoustic sensor.

2. Description of the Related Art

In a process of producing predetermined panels using a press machine, there is a need for inspecting the produced panels in real time.

In the related art, workers inspected whether there was a defect on panels or not with naked eyes. However, there are problems of slow inspection and low accuracy.

Further, when there is a problem inside a panel, it is not easily found and seriously influences the stability and efficiency of a finished product.

Accordingly, in a pressing process of producing panels, it is required to find at the early stage whether there is a defect or not such as fine deformation and fine cracks of the produced panels.

### SUMMARY OF THE INVENTION

An aspect of the present invention provides an apparatus for nondestructive crack inspection that can determine a defect of a product caused in a pressing process by applying a predetermined acoustic signal to an object to be inspected and then sensing propagation of the applied signal.

An aspect of the present invention also provides an apparatus for nondestructive crack inspection of which the inspection performance is improved by preventing external noise, using an acoustic sensor capable of sensing sounds in an audible band and a sound collector.

An aspect of the present invention also provides an apparatus for nondestructive crack inspection that can prevent defective panels from being put into the following process line by inspecting panels produced in a panel production line.

According to an aspect of the present invention, there is provided an apparatus for nondestructive crack inspection which inspects defects on panels produced in a pressing process, the apparatus comprising: an acoustic sensor sensing an acoustic signal in an audible band emitted from the panel; an amplifier amplifying and outputting an acoustic signal received by the acoustic sensor; a signal processor recognizing whether there is a defect by processing a signal outputted from the amplifier; and a sound collector disposed inside the acoustic sensor and collecting the acoustic signal.

The apparatus may further include a sound generator applying a sound to the panel.

The audible band that the acoustic sensor senses may range from 16 Hz to 20 kHz.

A plurality of the acoustic sensors may be provided.

The sound collector may have a conical shape and the acoustic sensor may be disposed at the center inside the sound collector.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram illustrating the configuration of an apparatus for nondestructive crack inspection according to an embodiment of the present invention; and

FIG. 2 is a diagram illustrating an example of arrangement of a sound collector and an acoustic sensor used in the present invention.

### DETAILED DESCRIPTION OF THE PREFERRED EMBODIMENT

Exemplary embodiments of the present invention will now be described in detail with reference to the accompanying drawings.

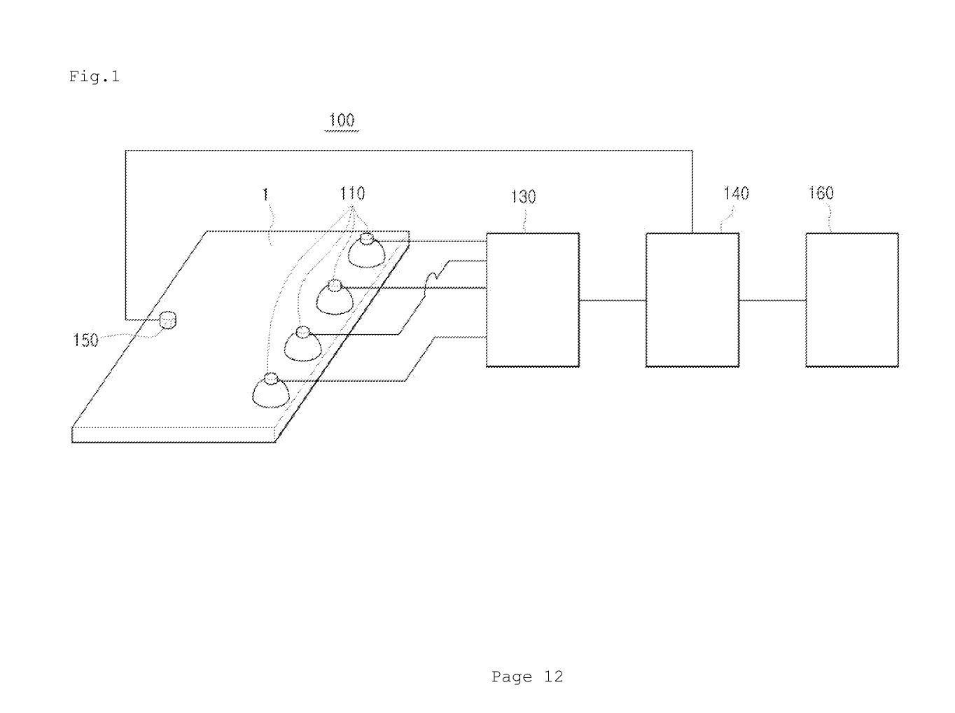

FIG. 1 is a block diagram illustrating the configuration of an apparatus for nondestructive crack inspection according to an embodiment of the present invention.

Referring to FIG. 1, an apparatus 100 for nondestructive crack inspection according to an embodiment of the present invention includes an acoustic sensor 110, a sound collector 120, an amplifier 130, and a signal processor 140.

First, a sound emitted from a panel 1 is briefly explained.

When stress is generated in a predetermined structure, the structure transits from an elastic region to a plastic region and plastic deformation is generated, and when the stress increases, defects such as fine deformation and fine cracks are generated and developed, resulting in failure of the structure. In this process, deformation energy accumulated in the structure is emitted in the form of an elastic wave in each stage from the plastic region and propagated in the structure as an acoustic emission signal that is an elastic wave. The acoustic emission signals that are elastic waves start to be attenuated, depending on the propagation distance, the formation and the type of the medium, so they are sensed at different positions from the origin at different times.

The acoustic sensor 110 senses audio-band acoustic signals emitted from the panel 1, which is an object to be measured, and outputs signals corresponding to the sensed sounds.

The sound signals sensed by the acoustic sensor 110 may be in an audio band having a frequency from 16 Hz to 20 kHz.

The acoustic sensor 110 may be an AE (Acoustic Emission) sensor measuring elastic waves (Acoustic Emission; AE).

A plurality of acoustic sensors 110 may be provided.

In the figures, the sound collector 120 is used for arranging the acoustic sensor 110.

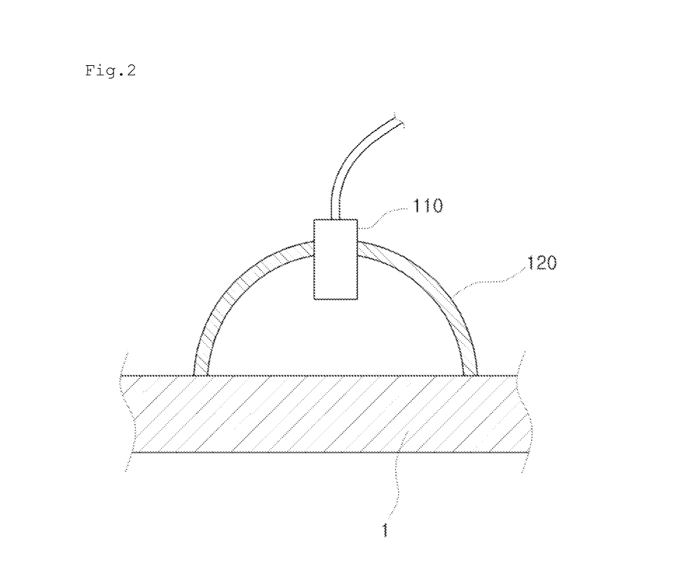

FIG. 2 is a diagram illustrating an example of arrangement of a sound collector and an acoustic sensor used in the present invention.

Referring to FIG. 2, the sound collector 120 has a conical shape with a predetermined size and is disposed with the acoustic sensor 110 at the center therein and an open side on the panel 1.

The sound collector 120 disposed on the panel 1 can keep the position pressed by atmospheric pressure and may be detached, if necessary.

The sound collector 120 can collect sounds emitted from the panel 1 and transmit them to the acoustic sensor 110 and can prevent external noise from traveling to the acoustic sensor 110.

A plurality of acoustic sensors 110 may be arranged with regular intervals. Although the acoustic sensors 110 are arranged in a straight line at a side on the panel 1 in FIG. 1, the present invention is not limited and the types and gaps of the arrangement may be changed in various ways.

The amplifier 130 is connected with the acoustic sensors 110 through signal lines and amplifies and outputs signals outputted from the acoustic sensors 110, at a predetermined level. The degree of amplifying signals by the amplifier 130 may be changed in accordance with a user's demand.

The signal processor 140 recognizes cracks in the panel 1 that is an object to be measured, by processing signals amplified and outputted from the amplifier 130.

The signal processor 140 recognizes cracks in the panel 1 on the basis of the sensing results of the plurality of the acoustic sensors 110, respectively.

First, the signal processor 140 can locate a defect on the basis of the respective sensing results of the plurality of the acoustic sensors 110.

That is, a predetermined acoustic signal is emitted from a predetermined position where a defect is generated on the panel 1. The emitted acoustic signal can be sensed by the acoustic sensors 110. The distances between the plurality of the acoustic sensors 110 and a defect are relatively different in accordance with the arranged positions, so the acoustic sensors 110 sense an acoustic signal at different times.

The signal processor 140 calculates the distances between an acoustic signal emission position (a defect position) and the acoustic sensors 110, using a distance that sound travels per second, and can find the defect position on the panel 1, using the distances.

Further, the signal processor 140 can calculate the size of a defect from the magnitude of an input signal.

When the panel 1 is just placed, any specific sound is not generated from the panel 1. To this end, the apparatus may further include a sound generator 150 that is apart for applying a predetermined sound to the panel 1.

The sound generator 150, a component for applying a predetermined signal to the panel 1, can apply a sound to the panel 1, using a predetermined device (speaker, and the like.) selected by a user.

The applied sound is transmitted from an end to another end of the panel 1. A sound can be transmitted without specific distortion, when there is no defect on the panel 1. When there is a defect on the panel 1, a sound passing through the defect may be distorted, depending on the shape of the defect, and the signal processor 140 receiving the distorted sound through a sensor can recognize the defect on the panel 1, depending on the degree of the distortion.

According to the present invention, it is possible to determine a defect on a product caused in a pressing process by applying a predetermined acoustic signal to an object to be inspected and then sensing propagation of the applied signal, and it is possible to improve inspection performance, using an acoustic sensor capable of sensing sounds in an audible band and a sound collector that collects sounds and prevents noise. Further, according to the present invention, it is possible to prevent defective panels from being put into the next process line by inspecting panels produced in a panel production line.

As set forth above, according to exemplary embodiments of the invention, it is possible to determine a defect on a product caused in a pressing process by applying a predetermined acoustic signal to an object to be inspected and then sensing propagation of the applied signal, and it is possible to improve inspection performance, using an acoustic sensor capable of sensing sounds in an audible band and a sound collector that collects sounds and prevents noise.

Further, according to the present invention, it is possible to prevent defective panels from being put into the next process line by inspecting panels produced in a panel production line.

While the present invention has been illustrated and described in connection with the exemplary embodiments, it will be apparent to those skilled in the art that modifications and variations can be made without departing from the spirit and scope of the invention as defined by the appended claims.

1. An apparatus for nondestructive crack inspection which inspects defects on panels produced in a pressing process, the apparatus comprising:
an acoustic sensor sensing an acoustic signal in an audible band emitted from the panel;
an amplifier amplifying and outputting an acoustic signal received by the acoustic sensor;
a signal processor recognizing whether there is a defect by processing a signal outputted from the amplifier; and
a sound collector disposed inside the acoustic sensor and collecting the acoustic signal.

2. The apparatus of claim 1, further comprising a sound generator applying a sound to the panel.

3. The apparatus of claim 1, wherein the audible band that the acoustic sensor senses ranges from 16 Hz to 20 kHz.

4. The apparatus of claim 1, wherein a plurality of the acoustic sensor are provided.

5. The apparatus of claim 1, wherein the sound collector has a conical shape and the acoustic sensor is disposed at the center inside the sound collector.

6. The apparatus of claim 4, wherein the sound collector has a conical shape and the acoustic sensor is disposed at the center inside the sound collector.
